(19) United States
(12) Patent Application Publication
(10) Pub. No.: US 2013/0174645 A1
(43) Pub. Date: Jul. 11, 2013

(54) PHOTOACOUSTIC METHOD FOR OXYGEN SENSING

(71) Applicants: Martin Willett, Waterlooville (GB); Michael Poulter, Waterlooville (GB); Viorel Avramescu, Bucharest (RO)

(72) Inventors: Martin Willett, Waterlooville (GB); Michael Poulter, Waterlooville (GB); Viorel Avramescu, Bucharest (RO)

(21) Appl. No.: 13/345,176

(22) Filed: Jan. 6, 2012

(51) Int. Cl. G01N 9/00

(52) U.S. Cl. 73/30.04

(57) ABSTRACT

A method for photoacoustically sensing oxygen in a gaseous sample is disclosed, together with an apparatus for practicing the present method. Efficient and cost-effective oxygen sensing is provided by the use of a light source in the form of a light-emitting diode, which can be selected to correspond with the absorption spectra exhibited by oxygen in a gaseous sample. Filtering can be employed in order to control and narrow the wavelength of light emitted by the light source. An apparatus is disclosed which facilitates practice of the present method, including an arrangement by which ambient noise and vibration can be canceled.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD

The present disclosure relates to a method and apparatus for detecting oxygen in a gaseous sample, and more particularly to a method of detecting oxygen in a gaseous sample photoacoustically by directing a light source in the form of a light-emitting diode into the gaseous sample.

### BACKGROUND

A number of technologies are known for the detection of ambient oxygen. However, as will be recognized by those familiar with the art, these various methods have certain drawbacks. For example, liquid electrolyte galvanic cells typically offer limited environmental range, due to the aqueous nature of their electrolytes, and typically exhibit limited service lives in view of the consumption of the anode material.

Low temperature oxygen pumps typically do not have consumable elements, but can also be limited by electrolyte performance. High temperature pumps, using solid electrolytes, typically require large amounts of power to maintain their elevated operating temperature.

In this context, there is a continuing need for compact, low power consumption oxygen sensors which can operate across a wide range of environmental conditions, at low operating costs.

It has been recognized that drawbacks associated with oxygen sensing methods, such as noted above, might be overcome by using a direct optical absorption method. However, heretofore the use of such detection techniques has been limited, in view of the size and complexity, and power consumption requirements of an arrangement providing useful levels of sensitivity and selectivity. As a consequence, such systems have been limited to relatively high performance, high cost, high-powered applications. Relatively long pathlength optical absorption chambers are also typically required to achieve required levels of performance. As such, these attributes mitigate against the use of optics in such an application, due to the unfavorable cost versus performance tradeoff, when compared to the performance/costs offered by an electrochemical cell.

Notably, experience with modern photoacoustic (PA) designs, which has been gained from work on sensors used for methane and carbon dioxide, has shown that such photoacoustic systems offer relatively greater sensitivity, per unit optical absorption, than can be achieved with other low cost optical absorption detection systems. The cost of a photoacoustic system for the above-mentioned gases can be low since a tungsten filament bulb, used as a black body light source, and non-resonant detection chamber, are both relatively inexpensive. The selection of useful wavelengths is accomplished with a conventional optical filter. The optical power delivered by the hot filament, as well as the use of a relatively large optical band free of interference, specific for each gas, ensures the required sensitivity for this type of photoacoustic cell.

Unfortunately, experience has shown that this relatively simple photoacoustic approach, requiring only a change in filter wavelength to tune the system to a different gas, is not applicable for many gases, including toxic species. This is because in normal ambient environments, it is very difficult to find a spectral range free of interference for each species. Moreover, the weak optical absorption of some spectral features, together with the low concentrations (parts per million) which must be detected, has typically meant that simple broadband, non-resonant photoacoustic systems are inappropriate for this type of gas detection.

Notably, an exception is found with oxygen. Based upon careful analysis of the absorption spectra for standard atmospheres, using HITRAN (high resolution transmission) data, oxygen is found to have an optical absorption band free of interference from other gases in the range of 750 nanometer (nm) to 780 nm. The optical power delivered by a micro-sized hot filament in this wavelength range is ten times lower than that for carbon dioxide, at 4.23 microns. Moreover, light absorption for 20% oxygen in atmosphere at 760 nm is three times lower than that for 380 ppm of carbon dioxide at 4.23 microns. Accordingly, in order to achieve comparable sensitivity with the same microphone in the same photoacoustic cell as can be used for carbon dioxide, the optical power of the light source must be increased.

In accordance with the present disclosure, this improved performance for a photoacoustic system, for sensing oxygen in a gaseous sample, can be achieved by replacing the typical micro-sized hot filament with a high power light source in the form of a light-emitting diode (LED).

### SUMMARY

In accordance with the present disclosure, a method of broadband photoacoustic oxygen sensing is provided, together with an apparatus for practice of the present method. The present disclosure contemplates that a cost-effective arrangement for sensing oxygen in a gaseous sample, which exhibits the necessary sensitivity and selectivity, can be achieved by providing the light source in the form of a light-emitting diode, which will illuminate a gaseous sample to be tested. Photoacoustic sensing is employed, whereby the pressure signal generated by the thermal wave created by the oxygen sample, will determine the concentration of oxygen in the sample.

In accordance with the present disclosure, a method of detecting oxygen in a gaseous sample comprises the steps of providing a light source having a wavelength of 750-780 nm, wherein light source comprises a light-emitting diode. The present method further entails directing the light source into the gaseous sample, and photoacoustically sensing the concentration of oxygen in the sample. For some applications, it can be desirable to filter the light source in order to narrow the bandwidth of light emitted thereby.

An apparatus for practicing the present method includes a chamber for containing the gaseous sample, and a light source, comprising a light-emitting diode, having a wavelength in the range of 750-780 nm for direction into the gaseous sample in the chamber. A photoacoustic sensor operatively associated with the chamber senses the concentration of oxygen in the gaseous sample when the light source is directed into the sample. In the illustrated embodiment, the chamber comprises a first chamber, with a second chamber provided for containing another gaseous sample, like the first gaseous sample. Another photoacoustic sensor is operatively associated with the second chamber for sensing oxygen in the gaseous sample in the second chamber, but the second chamber is not illuminated by the light-emitting diode. By this arrangement, ambient noise and vibration can be canceled by comparing the sensor signals.

Other features and advantages of the present disclosure will be readily apparent from the following detailed description, the accompanying drawings, and the appended claims.

### BRIEF DESCRIPTION OF THE DRAWINGS

FIG. 1 is a graphical representation of the optical absorption spectra for oxygen and water;

FIG. 2 is a graphical representation of the typical emission spectra of a high power light emitting diode; and

FIG. 3 is a diagrammatic view of an apparatus for practicing the photoacoustic oxygen sensing method of the present disclosure.

### DETAILED DESCRIPTION

While the present method and apparatus are susceptible of embodiment in various forms, there is shown in the drawings and will herein after be described presently preferred embodiments, with the understanding that that present disclosure is to be considered as an exemplification of the present method and apparatus, it is not intended to limit the disclosure to the specific embodiments illustrated and described herein.

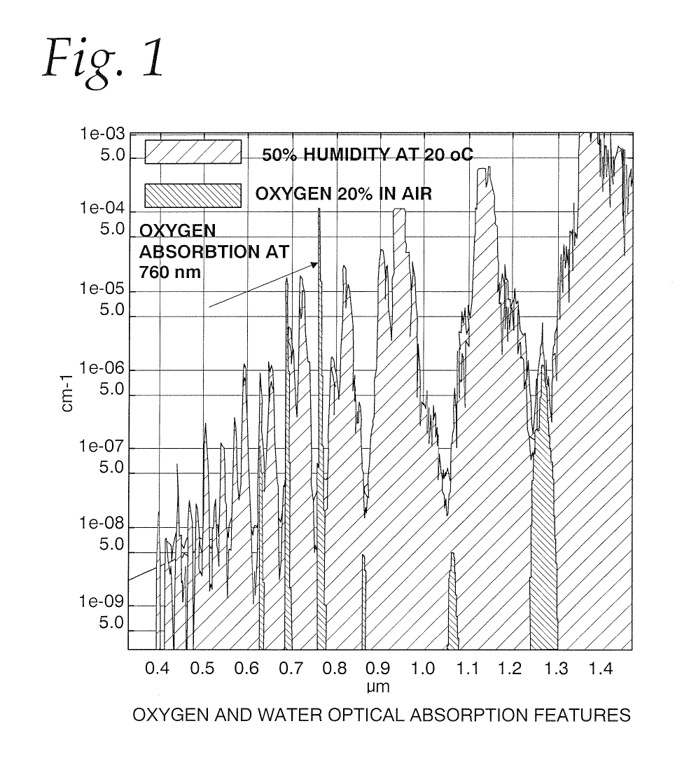

With reference now to FIG. 1, therein is graphically illustrated optical absorption features for oxygen and water, with 50% humidity at 20° C. and 20% in air oxygen concentration. Based upon careful analysis of this absorption spectra for standard atmospheres, using a HITRAN database, it has been determined that oxygen has an optical absorption band free of interferences from other common gases in the range of 750-780 nm.

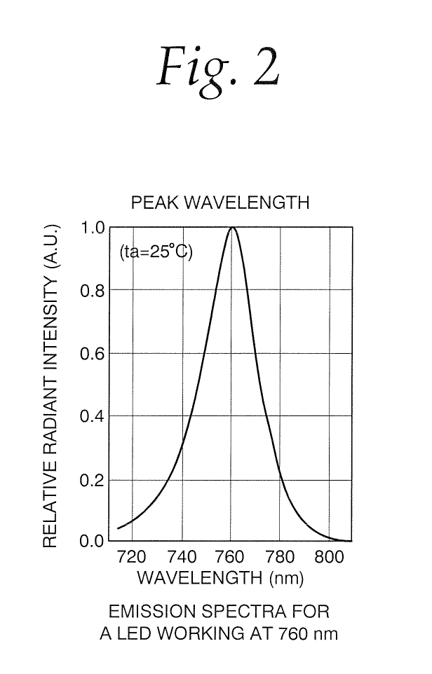

In accordance with the present disclosure, it has been determined that the concentration of oxygen in a gaseous sample can be photoacoustically determined by providing a light source in the form of a high power light-emitting diode (LED). Notably, such light-emitting diodes are commercially available at relatively low prices. While semiconductor lasers are capable of delivering similar or higher optical power, such lasers currently are 10-100 times more expensive than light-emitting diodes. A typical emission spectra of a high power light-emitting diode is shown in FIG. 2. The bandwidth of the light-emitting diode is sufficiently narrow as to permit the diode to be used in a photoacoustic cell, without the need for an additional filter. However, if required, such as to enable use of a broader bandwidth light emitting diode, band pass filters with “full width at half maximum” (FWHM) less than 20 nm are commercially available for 760 nm.

Thus, practice of the present method for detecting oxygen in a gaseous sample comprises providing a light source having a wavelength in the range of 750-780 nm, with the light source comprising a light-emitting diode. By directing the light source into the gaseous sample, the concentration of the oxygen in the sample can be photoacoustically sensed. As noted, filtering of the light source, in order to narrow the bandwidth of the light emitted by the source, can desirably permit use of a variety of different light-emitting diodes.

Notably, the present method contemplates that ambient noise and vibration can be canceled during the step of photoacoustically sensing the oxygen concentration, by photoacoustically testing a like gaseous sample, without illumination from the light-emitting diode.

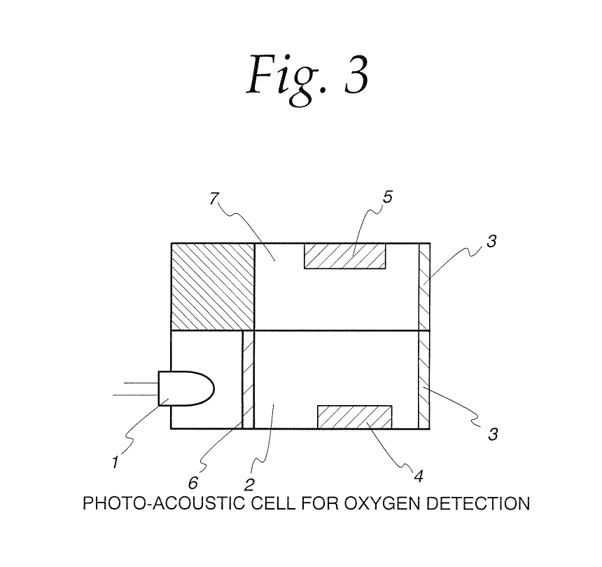

FIG. 3 diagrammatically illustrates an apparatus for practice of the present invention. The apparatus includes a light source in the form of a light-emitting diode 1 which is used to illuminate a chamber 2 into which ambient gas may diffuse through a permeable membrane 3 to provide the gaseous sample for which the concentration of oxygen is to be sensed. Notably, the use of a membrane 3 is a significant improvement over typical photoacoustic sensing arrangements, which typically employ mechanical valves to seal off a gaseous sample and to retain the maximum press pulse for detection, since such valve arrangements require a balance between speed of response, and pressure leakage.

The gaseous sample within the chamber 2 is illuminated by the light-emitting diode 1. As the light-emitting diode is modulated, the absorption processes within the oxygen in the gaseous sample generate a thermal wave which is detected as a pressure signature by a microphone 4 operatively connected to the chamber using known lock-in techniques. Thus, the concentration of oxygen within the gaseous sample is photoacoustically sensed.

Depending upon the specific light-emitting diode employed as the light source, a filter 6 can be inserted and positioned between the light-emitting diode 1 and the detection chamber 2. In this manner, the wavelength of light emitted by the light source can be narrowed, as may be required to enhance oxygen sensing.

In the illustrated embodiment, the present apparatus comprises a first detection chamber 2, with a second chamber 7 provided. The second chamber 7 is provided with a second microphone 5, identical to the microphone 4. Another gaseous sample, like the gaseous sample within chamber 2, can enter and defuse into the chamber 7 through membrane 3, but the gaseous sample in chamber 7 is not illuminated by the light source comprising light-emitting diode 1. In this manner, comparison of the signals provided by microphones 4 and 5 provides a system by which to cancel out ambient noise and vibration.

Notably, in comparison to broadband systems based on a filament bulb, a light-emitting diode desirably affords the opportunity to modulate at a significantly greater frequency than the few Hertz of modulation which are possible with a thermal device. As a result, significant advantages in signal detection and processing are achieved.

Although certain embodiments disclosed herein have been described in detail above, other modifications are possible. Other steps may be provided, or steps may be eliminated, from those described above, and other components may be added to or removed from, the described systems. Other embodiments may be within the scope of the following claims.

What is claimed is:

1. A method of detecting oxygen in a gaseous sample, comprising the steps of;
providing a light source having a wavelength in the range of 750-780 nm, said light source comprising a light-emitting diode;
directing the light source to the gaseous sample; and
photoacoustically sensing the concentration of oxygen in the gaseous sample.

2. A method of detecting oxygen in a gaseous sample in accordance with claim 1, including filtering the light source in order to narrow the bandwidth of the light emitted by the light source.

3. A method of detecting oxygen in a gaseous sample in accordance with claim 1, including providing a chamber having a membrane, and permitting said gaseous sample to diffuse through said membrane and into said chamber for directing the light source into the gaseous sample.

4. A method of detecting oxygen in a gaseous sample in accordance with claim 3, including canceling ambient noise and vibration during said step of photoacoustically sensing the concentration of oxygen in the gaseous sample.

5. A method of detecting oxygen in a gaseous sample in accordance with claim 5, wherein
said canceling step includes providing another chamber into which another gaseous sample, like said gaseous sample, is photoacoustically tested for the concentration of oxygen in the another gaseous sample without illumination from said light source.

6. An apparatus for detecting oxygen in a gaseous sample, comprising:
a first chamber for containing said gaseous sample;
a light source, comprising a light-emitting diode, having a wavelength in the range of 750-780 nm for direction into the gaseous sample in said first chamber; and
a photoacoustic sensor operatively associated with said chamber for sensing the concentration of oxygen in said gaseous sample when said light source is directed into said sample.

7. An apparatus for detecting oxygen in accordance with claim 6, including
a filter for narrowing the wavelength of the light emitted by said light source.

8. An apparatus for detecting oxygen in accordance with claim 6, including
a second chamber for containing another gaseous sample, like said gaseous sample, and another photoacoustic sensor operatively associated with said second chamber for sensing oxygen in the gaseous sample in said second chamber for canceling ambient noise and vibration by comparison of sensor signals.

9. An apparatus for detecting oxygen in accordance with claim 6, wherein said chamber includes a permeable membrane through which said gaseous sample diffuses into said chamber.
